(19) United States
(12) Patent Application Publication
(10) Pub. No.: US 2013/0147703 A1
(43) Pub. Date: Jun. 13, 2013

(54) DISPLAY DEVICE WITH OPTION INTERACTION

(71) Applicant: Chin-Tu TSAI, Taoyuan County (TW)

(72) Inventor: Chin-Tu TSAI, Taoyuan County (TW)

(73) Assignee: HERAN CO., LTD., Taoyuan County (TW)

(21) Appl. No.: 13/606,982

(22) Filed: Sep. 7, 2012

(30) Foreign Application Priority Data
Dec. 12, 2011 (TW) 100223411

(51) Int. Cl. G09G 5/00

(52) U.S. Cl. 345/156

(57) ABSTRACT

A display device with option interaction includes a display device and is characterized in that the display device is provided with an interaction device that is connected to a signal source. When an image is displayed on the display device to proceed with option interaction, the interaction device receives an option signal of the display device and provides backward transmission so as to provide the display device with a mechanism for interacting with a consultative program, making it easy to proceed with interaction for questionnaire, sampling, and voting, thereby allowing the user of the display device to participate in opinion expression for public affairs and improving efficiency, fairness, and impartiality in sampling society opinions.

### BACKGROUND OF THE INVENTION

1. Field of the Invention

The present invention relates to a display device with option interaction, and more particular to an arrangement that provides a display device with an interaction device to allow the display device to demonstrate interaction mechanisms, such as questionnaire, sampling, and voting, with a consultative programs and is applicable to various televisions, displays and the likes.

2. Description of Related Art

Television program channels have been increased from just a few channels in the early days to more than 100 channels of TV programs nowadays. In the early days, TV news channels provide only domestic and international news and announcement and publication of government decrees and today, a large number of news channels quickly emerge and make news broadcast available to the public for 24 hours every day, resulting in severe competition for audience rating.

Starting several years ago, news talk shows became available in the non-popular hours and guests were invited to joint the shows to discuss issues. Later, it became desired that the audience who sits in front of television to attend the shows and express their opinions. This lead to the emergence of call-ins, which allow the audience to express their opinions in the TV shows. However, due to the limited time period available in the TV shows, audience often get angry due to being incapable to have their calls answered and speaking out their comments in the shows. Nowadays, through to cooperation with telecommunication companies, some of the talk shows allow the audience to express their opinions through voice calls by providing telephones voting that allows audience to vote for options including “pro” and “con”, “yes” and “no”, or “like” and “dislike”, for certain questions discussed in the shows.

However, make voice calls t express opinions is every expensive, for each call is usually charged quite an amount. In addition, for each call made, the audience has to first listen to a voice message or instruction, which usually takes quite a period of time. Consequently, the telephone companies or the television station often earn quite an amount by simply receiving the calls from the public for opinion expression. This attracts other news channels to follow the voice call voting mechanisms. Other types of program, such as variety shows and competition shows, also apply the same mechanism of voice call voting to allow the audience to vote for their favor candidates or players. However, the high cost of making such calls also hinders the public from jointing such shows, preventing the public from expressing their opinions.

Thus, in view of the above discussed problems, the present invention aims to provide a display device with option interaction that allows a mechanism of interaction to be performed between the display device and a TV program and being easily controllable by a user.

### SUMMARY OF THE INVENTION

The primary object of the present invention is to provide a display device with option interaction, which provides an arrangement that a display device is provided with an interaction device that is connected to a signal source, whereby when an image is displayed on the display device to proceed with option interaction, the interaction device receives an option signal of the display device and provides backward transmission so as to provide the display device with a mechanism for interaction with a consultative program, thus improving the overall efficiency and easiness of operation.

Another object of the present invention is to provide a display device with option interaction, which is connectable to a database through a signal source, wherein the database stores data of options and may carry out analysis of option data so that instantaneous statistics can be made on the result for topics related to questionnaires, sampling, and voting and fast computation can be made to process various analyses of data to thereby improve the instantaneousness and convenience of the overall operation of the present invention.

In order to achieve the foregoing objects, the present invention provides a display device with option interaction, which comprises a display device and is characterized in that the display device is provided with an interaction device that is connected to a signal source, whereby when an image is displayed on the display device to proceed with option interaction, the interaction device receives an option signal of the display device and provides backward transmission so as to provide the display device with a mechanism for interaction with a consultative program, making it easy to proceed with interaction for questionnaire, sampling, and voting, thereby allowing the user of the display device to participate in opinion expression for public affairs and improving efficiency, fairness, and impartiality in sampling society opinions.

### BRIEF DESCRIPTION OF THE DRAWINGS

The present invention can be fully understood from the following detailed description and preferred embodiment with reference to the accompanying drawings, in which:

FIG. 1 is a schematic view showing an externally-mounted interaction device according to the present invention;

FIG. 2 is a block diagram showing the architecture of the externally-mounted interaction device according to the present invention;

FIG. 3 is schematic view showing operation of the externally-mounted interaction device according to the present invention with a remote control;

FIG. 4 is schematic view showing operation of the externally-mounted interaction device according to the present invention with touch control;

FIG. 5 is a schematic view showing a built-in interaction device according to the present invention;

FIG. 6 is a block diagram showing the architecture of the built-in interaction device according to the present invention;

FIG. 7 is schematic view showing operation of the built-in interaction device according to the present invention with a remote control; and

FIG. 8 is schematic view showing operation of the built-in interaction device according to the present invention with touch control.

### DETAILED DESCRIPTION OF THE PREFERRED EMBODIMENTS

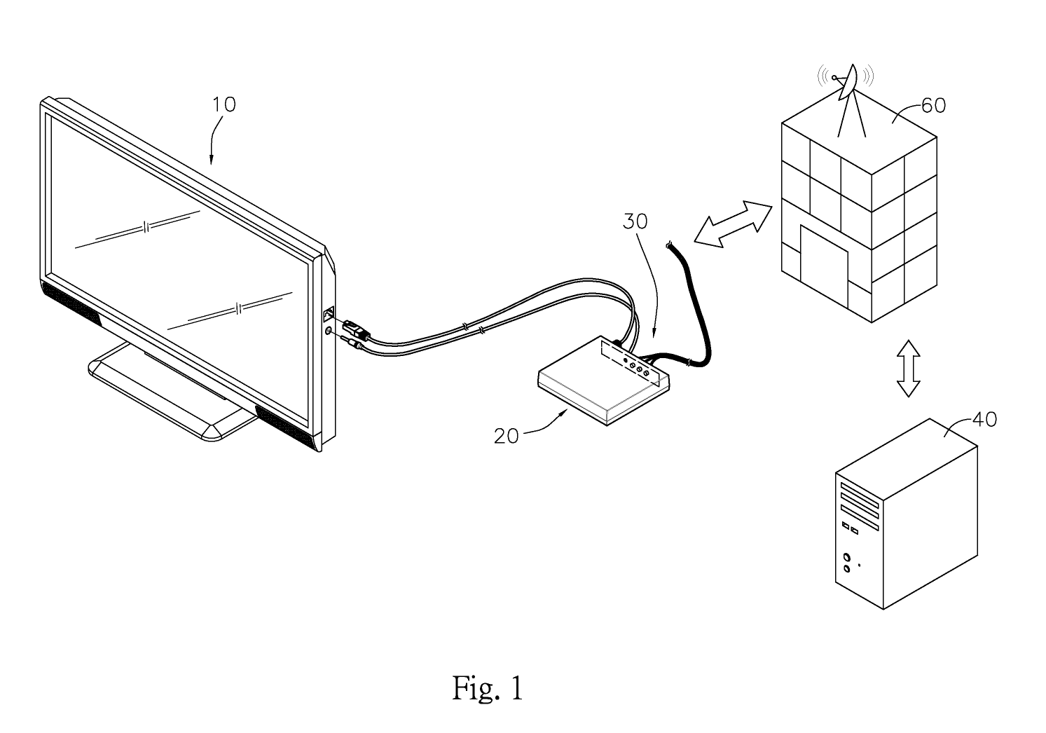

Referring to FIGS. 1-8, the present invention provides a display device with option interaction, which comprises a display device 10 and is characterized in that the display device 10 is provided with an interaction device 20. The interaction device 20 is connected to a signal source 30. When an image 11 is displayed on the display device 10 to proceed with option interaction, the interaction device 20 receives an option signal 12 of the display device 10 and provides backward transmission so as to provide the display device 10 with a mechanism for interacting with a program.

The interaction device 20 can be arranged outside the display device 10 and is connected to the display device 10 for transmission of signals. Alternatively, the interaction device 20 is built in the display device 10. The interaction device 20 comprises a signal processing unit 21, a control unit 22, and a corresponding code unit 23. The control unit 22 is connected to the signal processing unit 21 and the corresponding code unit 23. The signal processing unit 21 functions to supply an input of signal source 30 to display device 10. Further, when an option signal of the display device 10 is transmitted to the control unit 22 of the interaction device 20, the control unit 22 converts the option signal 12 of the display device 10 into an option corresponding code 231 through the corresponding code unit 23 and the option corresponding code 231 is then transmitted backward through the signal source 30 for immediate recognition. The signal source 30 is further connected to a database 40. The database 40 stores therein option data 41 and proceeds with instantaneous option data analysis 42. Further, the signal source 30 can be one of an analog TV signal 31, a digital TV signal 32, a cable TV signal 33, and a network TV signal 34. The option signal 12 of the display device 10 can be operated with a remote control 50. Alternatively, the option signal 12 of the display device 10 can be selected through clicking of the image 11. The display device 10 may comprises a touch screen 13 for clicking through touch. Further, the display device 10 can be any one of a liquid crystal display (LCD), a thin-film transistor liquid crystal display (TFT-LCD), an organic light-emitting display (OLED), a low temperature poly-silicon (LTPS) display, a projector display (PD), a vacuum fluorescent display (VFD), a plasma display panel (PDP), and a video display (TV).

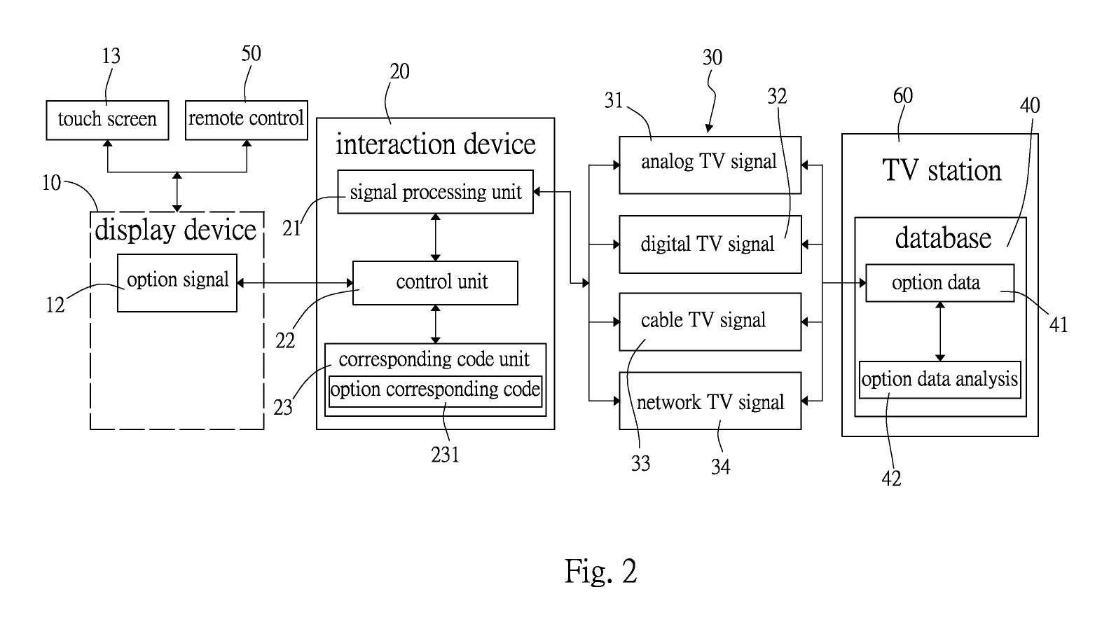

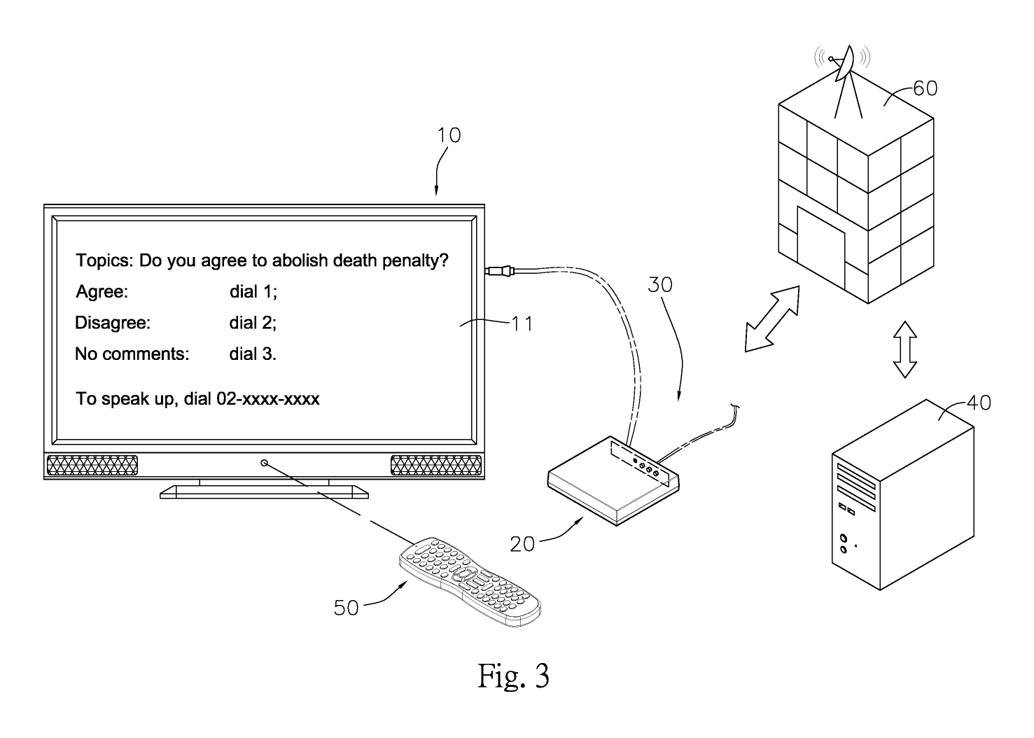

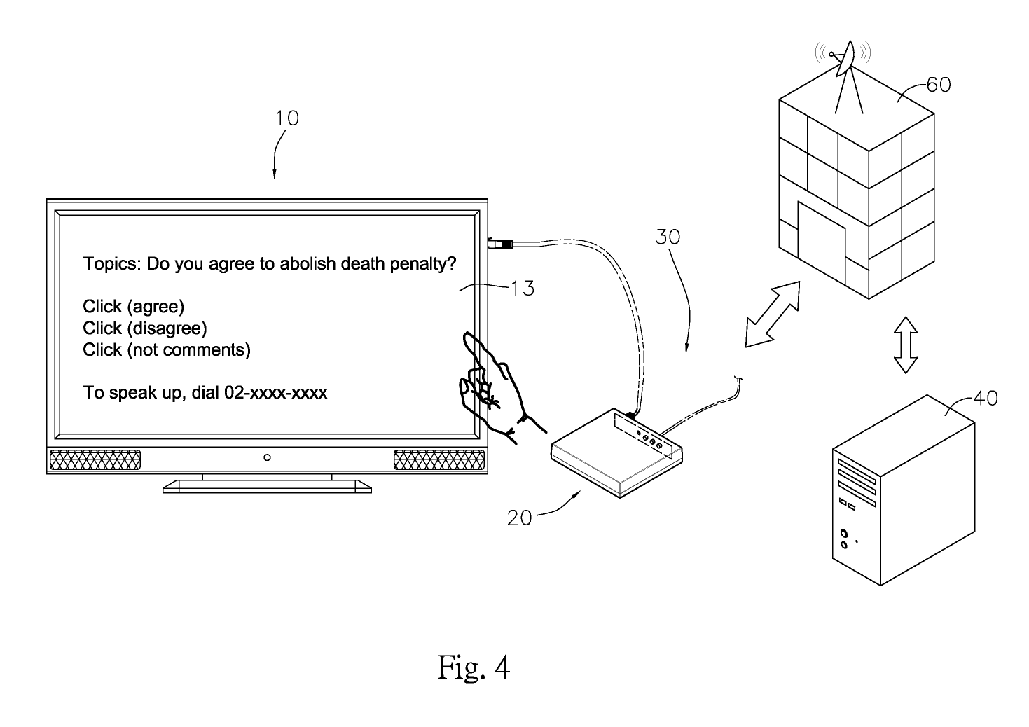

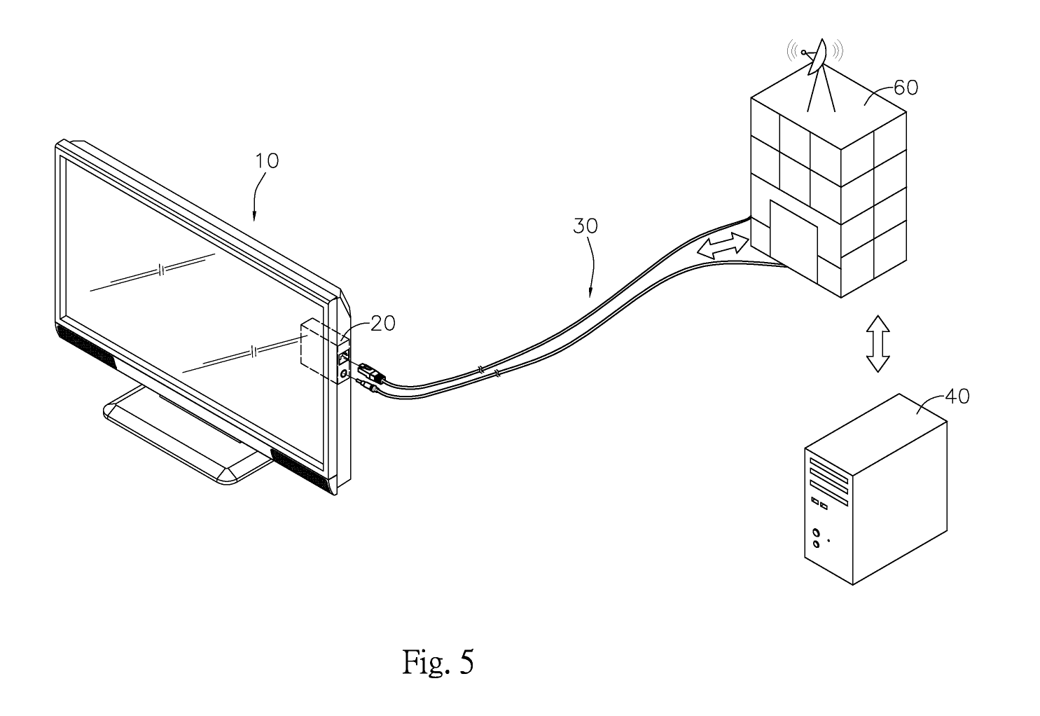

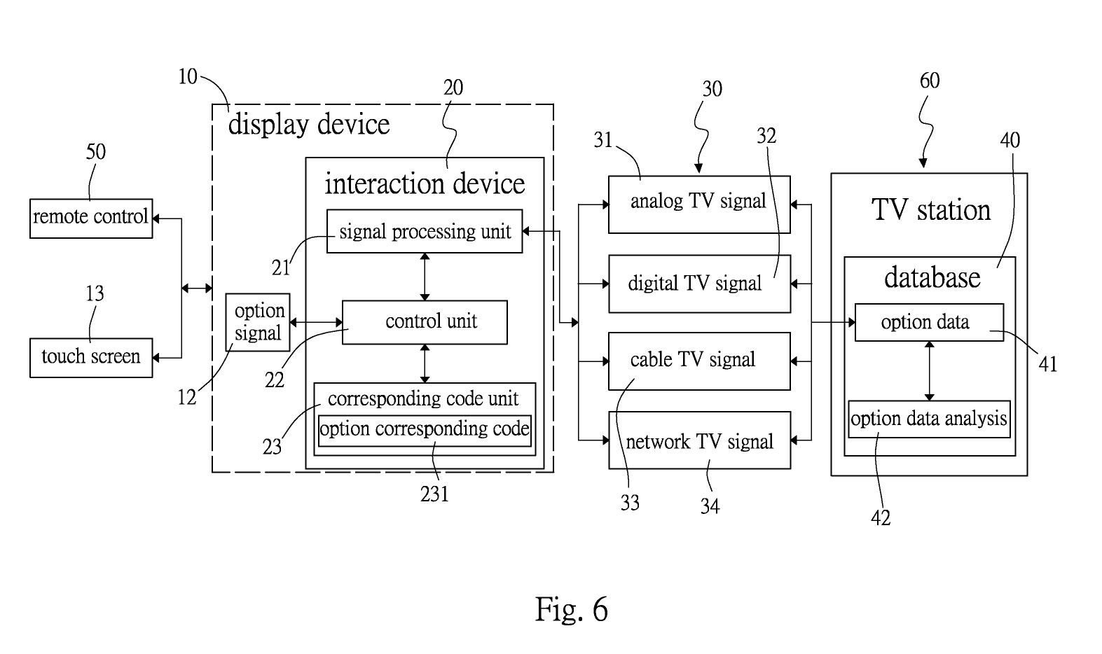

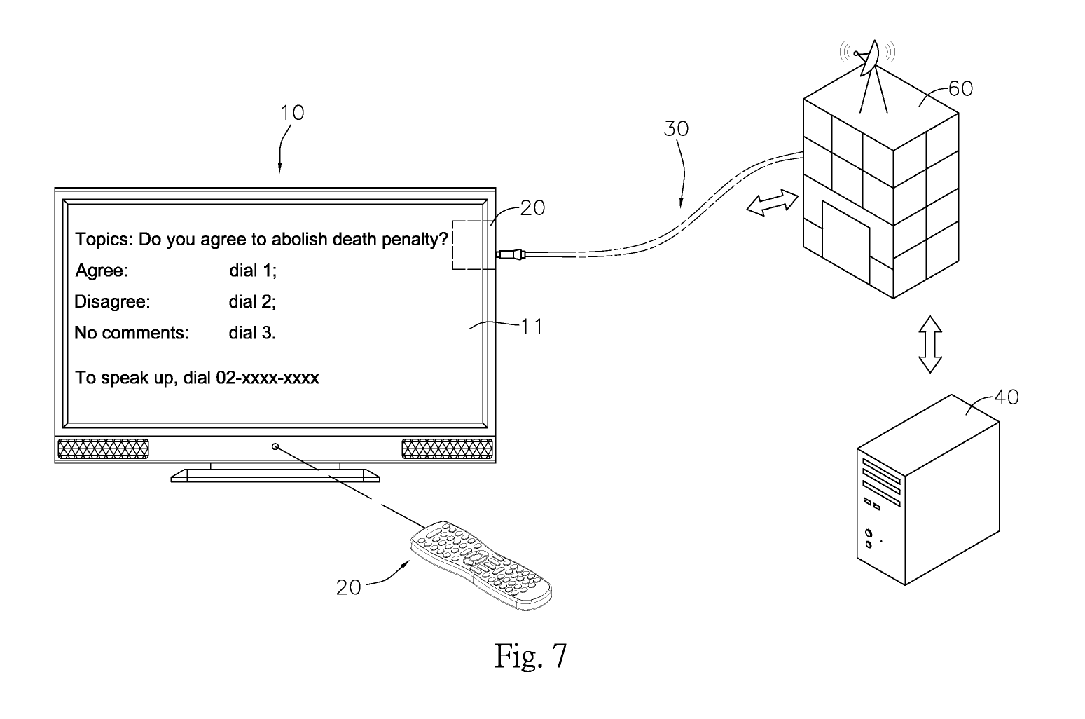

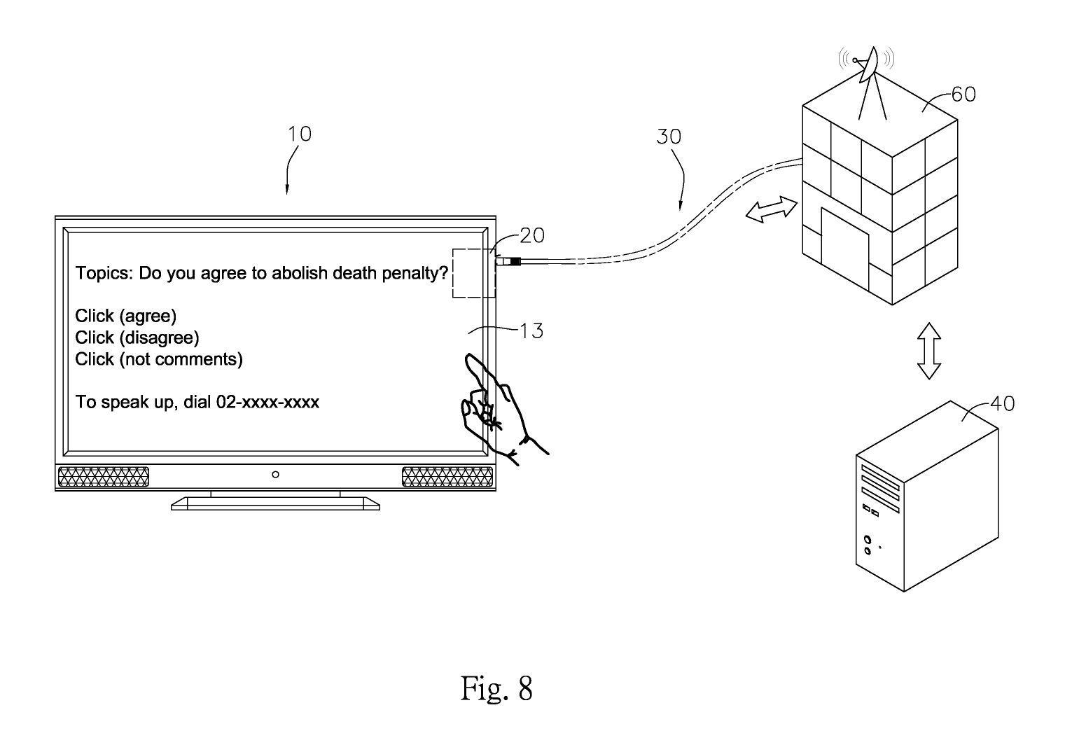

Referring to FIGS. 1-8, the present invention provides a display device with option interaction and a preferred way of practicing the present invention is to be embodied on a display device 10. The display device 10 can be any one of a liquid crystal display (LCD), a thin-film transistor liquid crystal display (TFT-LCD), an organic light-emitting display (OLED), a low temperature poly-silicon (LTPS) display, a projector display (PD), a vacuum fluorescent display (VFD), a plasma display panel (PDP), and a video display (TV). The video display, which is a television set, has the function of watching television programs. The display device 10 according to the present invention is provided with an interaction device 20. The interaction device 20 can be arranged outside the display device 10 and is connected to the display device 10 for transmission of signals (see FIG. 1). An alternative way of embodiment is that the interaction device 20 is built in the display device 10 (see FIG. 5). Whether being externally mounted or built in, the interaction device 20 is connected to internal control of the display device 10 to allow a signal source 30 to be transmitted through the interaction device 20 to the display device 10. The interaction device 20 is connected to the signal source 30 and the signal source 30 is one of an analog TV signal 31, a digital TV signal 32, a cable TV signal 33, a network TV signal 34 so that the interaction device 20 may receive interactive program contents transmitted from various signal sources 30 and interaction signals can be transmitted through the interaction device 20. The interaction device 20 comprises a signal processing unit 21, a control unit 22, and a corresponding code unit 23. The control unit 22 is connected to the signal processing unit 21 and the corresponding code unit 23. The signal processing unit 21 functions to supply an input of signal source 30 to display device 10 (see FIG. 2 or 6). As such, when interactive program contents are displayed on the image 11 of the display device 10 (or a TV screen) and an attempt is made to proceed with option interaction (such as voting options designed for a subject of debate in news programs, or answer options designed for questions of current affairs or general senses in variety shows, or questionnaire designed for products provided for an advertiser produced show), the audiences or consumers sitting in front of the display device 10 (TV set) may use a remote control 50 to operate (see FIG. 3 or 7) by pushing buttons corresponding to the options provided on the screen to generate an option signal 12. Alternatively, the display device 10 (TV set) comprises a touch screen 13 and buttons can be properly pressed down according to the options provided on the touch screen 13 so as to generate an option signal 12 (see FIG. 4 or 8). Both the option signal 12 generated with the remote control 50 and the option signal 12 generated through touch screen 13 are transmitted to the control unit 22 of the interaction device 20. The control unit 22 converts the option signal 12 into an option corresponding code 231 through the corresponding code unit 23 and the option corresponding code 231 is then transmitted via the signal source 30 back to a TV station 60 or a cable TV channel provider or a network provider. The signal source 30 is further connected to a database 40. The database 40 stores therein option data 41 and proceeds with instantaneous option data analysis 42 (see FIG. 2 or 6) so that instantaneous statistics can be made on the result for topics related to questionnaires, sampling, and voting to allow the result for the topics related to the questionnaires, the sampling, and the voting to be immediately displayed on the show, realizing a mechanism of interaction between the display device 10 (TV set) and the show to facilitate interactions for questionnaire, sampling, and voting, and encourage the participation of consumers to improve fairness thereof.

The description given above is sufficient to allow a person skilled in the art to understand that the present invention indeed achieves the objects mentioned above and completely complies with the requirements of patent regulations based on which a patent application is made for the present invention.

However, it is noted that what described above is only a preferred embodiment of the present invention, which is not given for limiting the scope of the present invention. Thus, all those simple and equivalent variation and modification made on the basis of the appended claims and the above disclosure are considered within the scope of patent protection of the present invention.

What is claimed is:

1. A display device with option interaction, comprising a display device, characterized in that the display device is provided with an interaction device that is connected to a signal source, wherein when an image is displayed on the display device to proceed with option interaction, the interaction device receives an option signal of the display device and provides backward transmission so as to provide the display device with a mechanism for interacting with a consultative program.

2. The display device with option interaction according to claim 1, wherein the interaction device is arranged outside the display device and is connected to the display device for transmission of signals.

3. The display device with option interaction according to claim 1, wherein the interaction device is built in the display device.

4. The display device with option interaction according to claim 1, wherein the interaction device comprises a signal processing unit, a control unit, and a corresponding code unit, the control unit being connected to the signal processing unit and the corresponding code unit, the signal processing unit functioning to supply an input of signal source to display device, whereby when an option signal of the display device is transmitted to the control unit of the interaction device, the control unit converts the option signal of the display device into an option corresponding code through the corresponding code unit and the option corresponding code is then transmitted backward through the signal source for immediate recognition.

5. The display device with option interaction according to claim 1, wherein the signal source is connected to a database, which stores therein option data and proceeds with instantaneous option data analysis.

6. The display device with option interaction according to claim 1, wherein the signal sources are selected from an analog television signal, a digital television signal, a cable television signal, or a network television signal.

7. The display device with option interaction according to claim 1, wherein the option signal of the display device is operated with a remote control.

8. The display device with option interaction according to claim 1, wherein the option signal of the display device is operated with clicking performed on an image and the display device comprises a touch screen for clicking through touch.

9. The display device with option interaction according to claim 1, wherein the display device is selected from a liquid crystal display (LCD), a thin-film transistor liquid crystal display (TFT-LCD), an organic light-emitting display (OLED), a low temperature poly-silicon (LTPS) display, a projector display (PD), a vacuum fluorescent display (VFD), a plasma display panel (PDP), and a video display (TV).

10. The display device with option interaction according to claim 2, wherein the interaction device comprises a signal processing unit, a control unit, and a corresponding code unit, the control unit being connected to the signal processing unit and the corresponding code unit, the signal processing unit functioning to supply an input of signal source to display device, whereby when an option signal of the display device is transmitted to the control unit of the interaction device, the control unit converts the option signal of the display device into an option corresponding code through the corresponding code unit and the option corresponding code is then transmitted backward through the signal source for immediate recognition.

11. The display device with option interaction according to claim 3, wherein the interaction device comprises a signal processing unit, a control unit, and a corresponding code unit, the control unit being connected to the signal processing unit and the corresponding code unit, the signal processing unit functioning to supply an input of signal source to display device, whereby when an option signal of the display device is transmitted to the control unit of the interaction device, the control unit converts the option signal of the display device into an option corresponding code through the corresponding code unit and the option corresponding code is then transmitted backward through the signal source for immediate recognition.
